(19) United States
(12) Patent Application Publication
(10) Pub. No.: US 2010/0248577 A1
(43) Pub. Date: Sep. 30, 2010

(54) OPTICAL DIFFUSER

(75) Inventors: Gareth Paul Bell, Auckland (NZ); Robert Craig, Auckland (NZ)

Correspondence Address: MURABITO, HAO & BARNES, LLP, TWO NORTH MARKET STREET, THIRD FLOOR, SAN JOSE, CA, 95113, US

(73) Assignee: PURE DEPTH LIMITED, Auckland (NZ)

(21) Appl. No.: 12/794,661

(22) Filed: Jun. 4, 2010

Related U.S. Application Data
(62) Division of application No. 11/893,419, filed on Aug. 15, 2007.

(51) Int. Cl. H01J 9/00; B05D 5/06; G02B 1/00; B29C 59/02; B29C 59/04; B32B 37/00; B29D 11/00

(52) U.S. Cl. 445/24; 156/60; 156/219; 156/191; 156/209; 427/162; 427/510

(57) ABSTRACT

An improved optical diffuser for use in a multi-component display (MCD), and also to a method of manufacturing the same, is disclosed. Embodiments provide an optical diffuser film which may be manufactured with fewer manual operations, at a lower cost, and in larger volume than conventional optical diffusers. The optical diffuser film may include a flexible polymer substrate coupled to an optical diffuser material with a plurality of features for diffusing light. The optical diffuser film may be stored, transported, or otherwise handled more easily and with less damage than conventional optical diffusers. Additionally, the optical diffuser film may be coupled to a rigid substrate to reduce distortion of the optical diffuser, thereby providing improved optical performance.

### RELATED APPLICATIONS

The present application is a divisional of U.S. patent application Ser. No. 11/893,419, filed Aug. 15, 2007, naming Gareth P. Bell and Robert Craig as inventors, assigned to the assignee of the present invention, and having attorney docket number PURE-P054, which claims the benefit of New Zealand Provisional Patent Application Number 549182, filed Aug. 15, 2006, entitled “IMPROVED DIFFUSER AND METHOD OF MAKING THE SAME,” naming Gareth Bell and Robert Craig as the inventors, and assigned to the assignee of the present invention. These applications are incorporated herein by reference in their entirety and for all purposes.

### BACKGROUND OF THE INVENTION

Multi-layer displays (MLDs), sometimes referred to as multi-component displays (MCDs), include multiple display screens (e.g., LCD displays) in a stacked arrangement. Each of the display screens may have its own set of color filters and/or its own matrix which covers the traces, leads and transistors of each pixel. When the display screens are overlaid, the repeated elements can produce visually-offensive banding or other interference patterns known as Moiré interference. As such, it is common to introduce an optical diffuser between the display screens of the MCD to reduce the Moiré interference.

FIG. 1 shows conventional process 100 for manufacturing a conventional optical diffuser. As shown in FIG. 1, epoxy 120 is applied to cell-cast acrylic substrate 110. Master pattern 130 is pressed into epoxy 120 while ultraviolet (UV) light is applied from light source 140 to cure epoxy 120. Once master pattern 130 is removed, diffuser element 125 remains with features 127, thereby forming conventional optical diffuser 150.

Conventional optical diffusers (e.g., 150) can only be produced in low volume and are expensive to manufacture. For example, each step depicted in FIG. 1 is performed manually, thereby limiting yield and increasing cost. Additionally, the cost of conventional optical diffuser 150 is high considering the relatively high cost of acrylic substrate 110. Moreover, acrylic substrate 110 is prone to distortion when heat is applied, thereby providing reduced optical performance in the presence of heat from backlight lamps and other components of the MCD during use.

### SUMMARY OF THE INVENTION

Accordingly, a need exists for an optical diffuser which can be produced in larger volumes and at lower cost. A need also exists for an optical diffuser with reduced distortion during use. Embodiments of the present invention provide novel solutions to these needs and others as described below.

Embodiments of the present invention are directed to an improved optical diffuser for use in a multi-component display (MCD), and also to a method of manufacturing the same. More specifically, embodiments provide an optical diffuser film which may be manufactured with fewer manual operations (e.g., as an automated roll-to-roll process), at a lower cost, and in larger volume than conventional optical diffusers. The optical diffuser film may include a flexible polymer substrate (e.g., polycarbonate, etc.) coupled to an optical diffuser material (e.g., UV-curable epoxy) with a plurality of features (e.g., embossed using a pressed or rolled master pattern) for diffusing light. The novel optical diffuser film may be stored, transported, or otherwise handled more easily and with less damage than conventional optical diffusers. Additionally, the optical diffuser film may be coupled (e.g., using a pressure-sensitive adhesive) to a rigid substrate (e.g., glass) to reduce distortion (e.g., thermally-induced distortion caused by backlight lamps, light emitting diodes (LEDs), or other light sources of the MCD during use) of the optical diffuser, thereby providing improved optical performance.

In one embodiment, an optical diffuser film includes a flexible polymer substrate. The optical diffuser film also includes an optical diffuser material with a first surface disposed on the flexible polymer substrate and a second surface including a plurality of features for diffusing light passed through the optical diffuser material. The flexible polymer substrate may include a polycarbonate film, where the polycarbonate film may be selected from a group consisting of solvent-cast polycarbonate film and chill-rolled polycarbonate film. Additionally, the optical diffuser material may include a polymer curable by ultraviolet light (e.g., a UV-curable epoxy, etc.). The flexible polymer substrate and the optical diffuser material may form an optical diffuser film for reducing Moiré interference associated with multi-component displays.

In another embodiment, an optical diffuser includes an optical diffuser film. The optical diffuser film includes a flexible polymer substrate and an optical diffuser material with a first surface disposed on the flexible polymer substrate and a second surface including a plurality of features for diffusing light passed through the optical diffuser material. A rigid substrate is disposed on the optical diffuser film for providing structural support for the optical diffuser film. The rigid substrate may include glass. Additionally, the rigid substrate may further be operable to reduce thermal deformation of the optical diffuser film. The optical diffuser may include a pressure-sensitive adhesive for adhering the optical diffuser film to the rigid substrate. The optical diffuser film and the rigid substrate may form an optical diffuser for reducing Moiré interference associated with multi-component displays.

In yet another embodiment, a multi-component display includes a first display and a second display overlapping the first display, wherein the first and second displays are capable of displaying graphical objects. An optical diffuser is disposed between the first and second displays, the optical diffuser including an optical diffuser film. The optical diffuser film includes a flexible polymer substrate and an optical diffuser material with a first surface disposed on the flexible polymer substrate and a second surface including a plurality of features for diffusing light passed through the optical diffuser material. The optical diffuser also includes a rigid substrate disposed on the optical diffuser film and for providing structural support for the optical diffuser film. The multi-component display may also include a backlight for generating light passed through the first display, the optical diffuser and the second display.

In another embodiment, a method of manufacturing an optical diffuser includes adhering an optical diffuser film to a rigid substrate, wherein the rigid substrate is operable to provide structural support for the optical diffuser film. The optical diffuser film may include a flexible polymer substrate and an optical diffuser material with a first surface disposed on the flexible polymer substrate and a second surface including a plurality of features for diffusing light passed through the optical diffuser material. The method may further include applying the optical diffuser material to the flexible polymer substrate and embossing the plurality of features into the optical diffuser material. The applying and the embossing may form a roll-to-roll process. Additionally, the embossing may further include applying a master pattern to the optical diffuser material (e.g., pressing a substantially-flat master pattern into the optical diffuser material, rolling a cylindrical master pattern over the optical diffuser material, etc.), the master pattern including a second plurality of features for forming the plurality of features in the optical diffuser material. The optical diffuser material may be cured to form the plurality of features in the optical diffuser material.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows conventional process 100 for manufacturing a conventional optical diffuser.

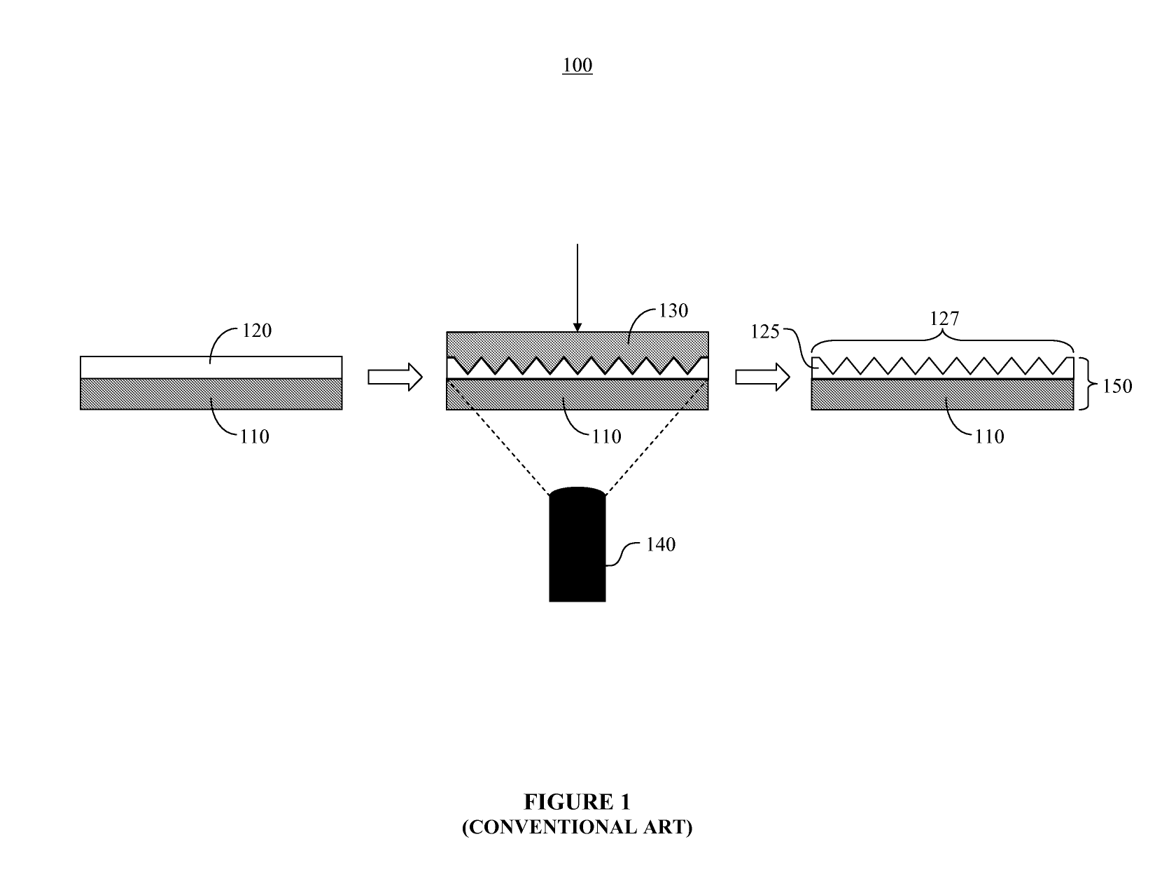

FIG. 2 shows an exemplary multi-component display with an optical diffuser in accordance with one embodiment of the present invention.

FIG. 3 shows an exemplary optical diffuser in accordance with one embodiment of the present invention.

FIG. 4 shows a diagram of exemplary production stages of an exemplary optical diffuser in accordance with one embodiment of the present invention.

FIG. 5 shows an exemplary manufacturing line for manufacturing exemplary optical diffuser film in accordance with one embodiment of the present invention.

FIG. 6 shows an exemplary manufacturing line for manufacturing exemplary optical diffusers in accordance with one embodiment of the present invention.

FIG. 7 shows an exemplary process for manufacturing an optical diffuser in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Embodiments of the Invention

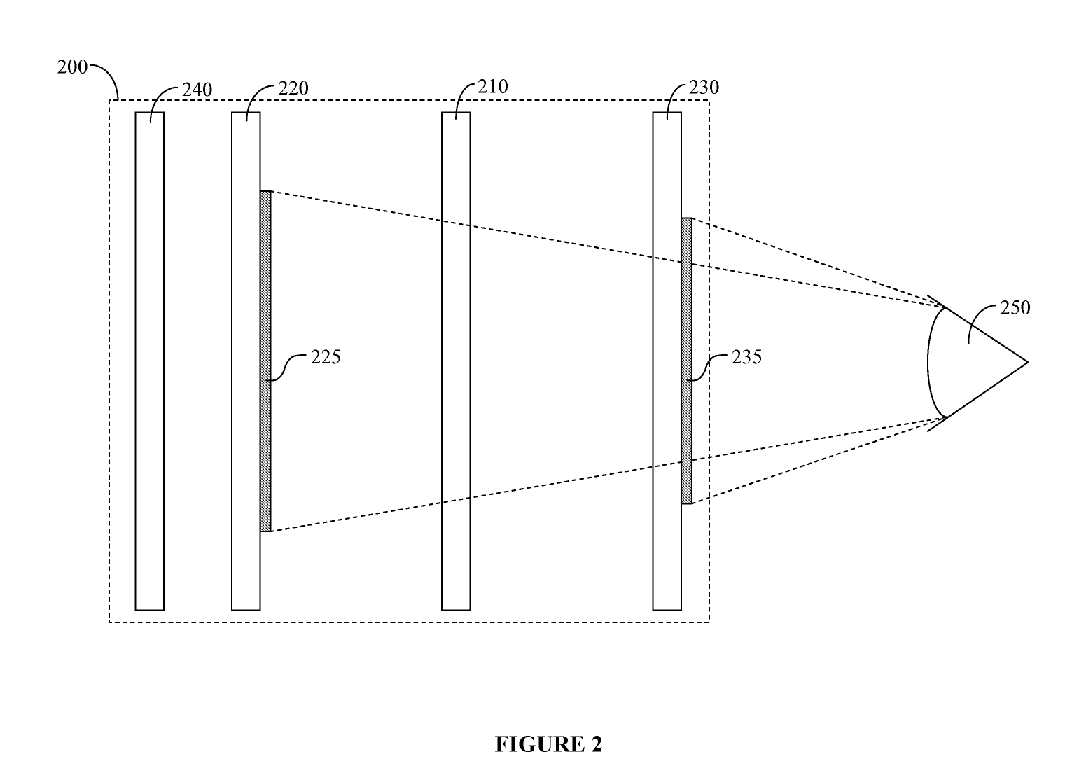

FIG. 2 shows exemplary multi-component display (MCD) 200 with an optical diffuser in accordance with one embodiment of the present invention. As shown in FIG. 2, MCD 200 comprises rear display screen 220, front display screen 230 and optical diffuser 210 disposed between display screens 220 and 230. Graphical objects 225 and graphical objects 235 may be displayed on display screens 220 and 230, respectively, for viewing by observer 250, where observer 250 may comprise a human eye, an electrical and/or mechanical optical reception component (e.g., a still-image camera, moving-image camera, etc.), etc. Additionally, backlight 240 (e.g., comprising one or more lamps, light-emitting components, etc.) may emit light to illuminate and aid viewing of graphical objects 225 and 235. Accordingly, it should be appreciated that optical diffuser 210 and/or front display screen 230 may be at least semi-transparent and transmit sufficient light, in one embodiment, to enable viewing of graphical objects (e.g., 225, 235, etc.) by observer 250.

Graphical objects 225 and/or 235 may comprise any visual display of a respective display screen (e.g., 220, 230, etc.). In one embodiment, graphical objects 225 and/or 235 may comprise still images. The still images may comprise stand-alone images, or alternatively, frames of a video or other moving imagery. Alternatively, graphical objects 225 and/or 235 may comprise frame-less moving imagery. Additionally, graphical objects 225 and/or 235 may comprise multiple distinct images, contiguous portions of the same image, non-contiguous portions of the same image, low-pass or high-pass filtered versions of the same image, etc.

As shown in FIG. 2, display screens 220 and/or 230 may comprise a liquid crystal display (LCD) matrix in one embodiment. Alternatively, display screens 220 and/or 230 may comprise light emitting diode (LED), organic light emitting diode (OLED) displays, transparent organic light emitting diode (TOLED) displays, cathode ray tube (CRT) displays, field emission displays (FEDs), field sequential display or projection displays. And in other embodiments, display screens 220 and/or 230 may comprise other display technologies.

Optical diffuser 210 may comprise an optical diffuser with a micro-structured profile (e.g., with features that are not visible to the naked eye and/or which manipulate light in ways that are not apparent to the naked eye) for reducing Moiré interference associated with MCD 200. Optical diffuser 210 may comprise a customized output scattering profile, a Gaussian profile, a triangular profile, a square profile, an elliptical profile, etc. In one embodiment, optical diffuser 210 may comprise a holographic diffuser. In other embodiments, optical diffuser 210 may provide other optical manipulation (e.g., filtering, retardation, polarization, etc.) of light (e.g., graphical objects 225 emitted from display 220, light emitted from backlight 240, etc.) passed through optical diffuser 210.

Although FIG. 2 shows optical diffuser 210 disposed between the front and rear display screens (e.g., 220 and 230), it should be appreciated that optical diffuser 240 may be alternatively positioned (e.g., disposed in front of front display screen 230) in other embodiments. It should be appreciated that MCD 200 may comprise other types of optical components (e.g., filters, polarizers, etc.) in place of or in addition to optical diffuser 210 in other embodiments. Additionally, although FIG. 2 shows only one optical diffuser (e.g., 210), it should be appreciated that MCD 200 may comprise more than one optical diffuser or other optical component in other embodiments, where each optical diffuser or other optical component may be placed in front of or behind display screen 220 and/or display screen 230.

Additionally, although FIG. 2 shows two display screens (e.g., 220 and 230), it should be appreciated that MCD 200 may comprise a larger or smaller number of display screens in other embodiments, where any additional display screens may be positioned behind, between or in front of (or any combination thereof) the MCD components (e.g., optical diffuser 210, display screen 220, display screen 230, backlight 240, etc.) depicted in FIG. 2. Further, it should be appreciated that the elements (e.g., 210-240) depicted in FIG. 2 are not drawn to scale, and thus, may comprise different shapes, sizes, etc. in other embodiments.

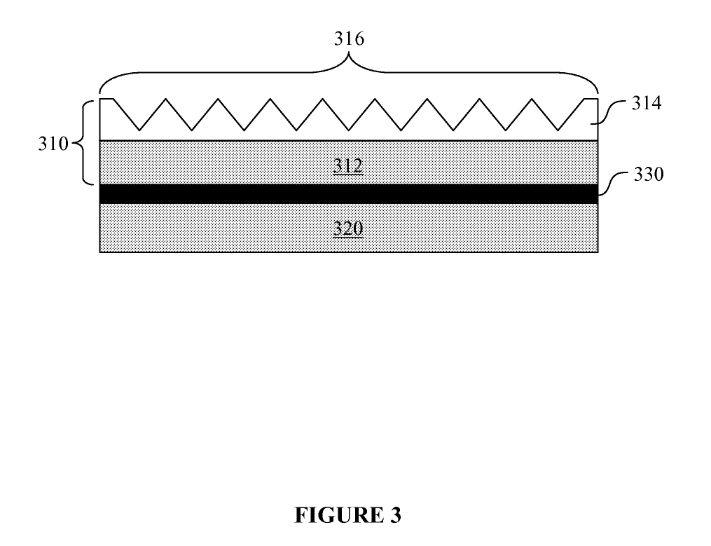

FIG. 3 shows exemplary optical diffuser 210 in accordance with one embodiment of the present invention. As shown in FIG. 3, optical diffuser 210 comprises optical diffuser film 310 coupled or adhered to substrate 320 by adhesive material 330. Optical diffuser film 310 comprises optical diffuser material 314 disposed on substrate 312, where optical diffuser material 314 comprises features 316 for diffusing light passed through optical diffuser material 314.

Substrate 312 may be flexible. For example, substrate 312 may be relatively thin (e.g. with a height substantially less than other dimensions associated with the surface coupled to optical diffuser material 314) or otherwise comprise a thin film, have mechanical properties enabling flexing or bending, etc. As such, optical diffuser film 310 may comprise a flexible optical diffuser film which can be stored, transported, or otherwise handled more easily and with less damage than conventional optical diffusers. For example, optical diffuser film 310 may be rolled into a roll when not in use, thereby providing a compact configuration (e.g., for storage, transportation, etc.) which also enables easy removal for use (e.g., unrolling optical diffuser film 310 from the roll for use).

As shown in FIG. 3, substrate 312 may comprise good optical characteristics (e.g., low birefringence, good optical transmission, low haze, etc.). Additionally, substrate 312 may comprise a material with a minimum surface energy of approximately 15 dynes/cm. For example, substrate 312 may comprise polycarbonate, polyester, polypropylene, polyethylene, polystyrene, ABS, polyamide, epoxy, polyester, rigid PVC, plasticized PVC, PET, polyimide, polyacetal, polyphenylene oxide, PBT, polysolfone, polyphenylene sulfide, nylon, polyethylene copolymer, fluorinated ethylene propylene, polyvinyl fluoride, silicone, natural rubber, styrene butadiene rubber, polymethyl methacrylate (PMMA), etc. A higher surface energy of substrate 312 may increase bonding strength with optical diffuser material 314 in one embodiment. Additionally, substrate 312 may comprise surface treatment (e.g., corona surface treatment) to increase bonding strength with optical diffuser material 314.

In one embodiment, substrate 312 may comprise a solvent-cast polycarbonate film such as Pokalon from LOFO High Tech Film of Germany, solvent-cast polycarbonate films from TEJIN Films of Japan, or solvent-cast polycarbonate films from GE of the United States. Alternatively, substrate 312 may comprise a chill-rolled polycarbonate film such as EUROPLEX 0F405 from Degussa. And in other embodiments, substrate 312 may be implemented using Arylite A100HC polyarylate from Ferrania, Zeonor ZF16-100 cyclic polyolefin from Zeon, or Ultrason E2010 Q28 polyethersulphone from BASF.

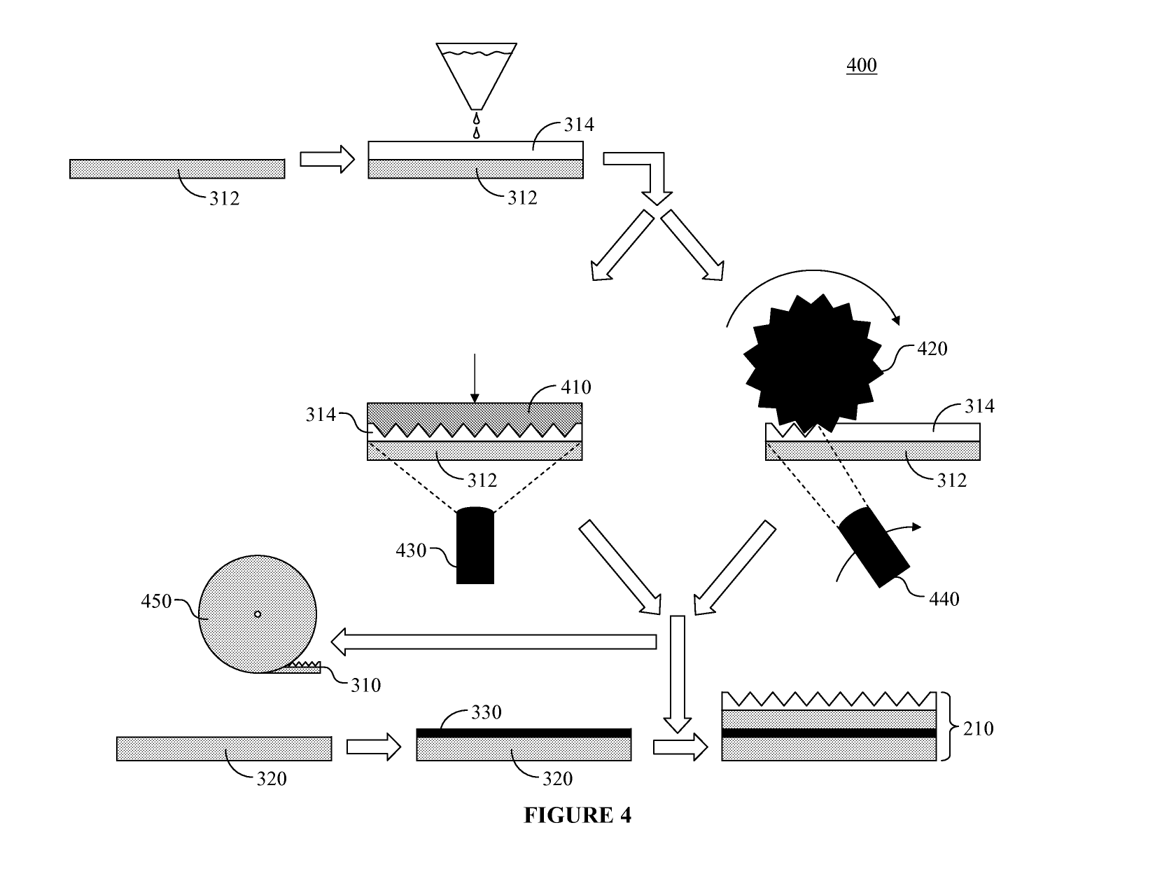

Optical diffuser material 314 may comprise a material whose curing can be controlled. For example, optical diffuser material may comprise a photosensitive material (e.g., which cures when exposed to ultraviolet light or other light), chemically-cured material, etc. As such, features 316 may be created in material 314 (e.g., using embossing as discussed below with respect to FIGS. 4-7) and held in place by the curing of material 314. Alternatively, the features may be created by chemical etching, calendaring, etc. of material 314 (e.g. after curing).

In one embodiment, optical diffuser material 314 may comprise a UV-curable epoxy with a viscosity of approximately 200-400 cps such as Gaffgaurd 233 from GAF corporation of New Jersey or AC PR153/AC PR155/AC PR157 from Addison Clear Wave of Illinois. Additionally, optical diffuser material 314 may comprise one or more additives (e.g., to increase bonding strength with substrate 312) such as 1,6-Hexanediol diacrylate or tetrahydrofurfuryl acrylate.

As shown in FIG. 3, substrate 320 may comprise a rigid substrate (e.g., that retains shape under thermal and/or mechanical loading) which may also have good optical characteristics (e.g., low birefringence, good optical transmission, low haze, etc.). As such, bending, flexing, or other distortion of optical diffuser film 310 may be reduced by coupling optical diffuser film 310 to substrate 320 (e.g., using adhesive material 330). In one embodiment, substrate 320 may reduce thermally-induced distortion caused by backlight 240 during operation of MCD 200. Thus, by reducing distortion of optical diffuser film 310 (e.g., during use), substrate 320 may improve the optical properties of optical diffuser film 310, and therefore, provide optical diffuser 210 with improved optical properties.

In one embodiment, substrate 330 may comprise glass (e.g., with a thickness of 1 mm to 10 mm). For example, glass sheet such as Schott Desag B270, Schott Borofloat, Schott D263T Borosilicate, Schott Robax Glass Ceramic, Schott AF45 Alkali-free glass, Vycor, or Float glass (soda lime) may be used. In other embodiments, other substrate materials may be used which provide maximum flatness variation of approximately 0.1 mm, a weight of approximately 0.01 g/mm², a minimum optical transmission of approximately 90%, a maximum color shift of approximately 0.004 uv, an allowable temperature range of −20 K to 85 K, a maximum linear coefficient of expansion of approximately 10 10⁻⁶/K, an acceptable humidity of approximately 8/95% RH, a minimum knoop hardness of approximately 565 kgf/mm², a maximum Young's modulus of approximately 7.2*10¹⁰ Pa, a maximum Poisson's Ratio of approximately 0.22, or some combination thereof.

In other embodiments, substrate 330 may comprise an LCD polarizer. Alternatively, substrate 330 may comprise one or more other optical components.

As shown in FIG. 3, adhesive material 330 may comprise any adhesive capable of coupling optical diffuser film 310 to substrate 320. In one embodiment, adhesive material 330 may comprise a pressure-sensitive adhesive such as 9611 PSA from Nitto Denko. Alternatively, adhesive material 330 may comprise other adhesives (e.g., AC PR153 from Addison Clear Wave of Illinois, etc.).

Although FIG. 3 shows optical diffuser material 314 with a specific pattern of features 316, it should be appreciated that optical diffuser material 314 may comprise other patterns in other embodiments. Additionally, it should be appreciated that the components (e.g., 310, 312, 314, 320 and 330) of optical diffuser 210 as depicted in FIG. 2 are not drawn to scale, and thus, may comprise different shapes, sizes, etc. in other embodiments.

FIG. 4 shows diagram 400 of exemplary production stages of exemplary optical diffuser 210 in accordance with one embodiment of the present invention. As shown in FIG. 4, substrate 312 may be accessed and optical diffuser material 314 may be applied thereto. Material 314 may be applied to substrate 312 in an uncured or viscous form. Additionally, it may be applied evenly over substrate 312, applied to one area of substrate 312 and spread to other areas, etc.

Once material 314 is applied to substrate 312, features 316 may be created. For example, master pattern 410 (e.g., a negative mold of features 316) may be pressed into optical diffuser material 314 and held there while light (e.g., ultraviolet light, etc.) from light source 430 is applied to cure material 314. Once material 314 is cured, master pattern 410 may be removed to reveal features 316 which are formed or held in place on the top surface of material 314.

Features 316 may also be created in material 314 by rolling master pattern 420 over material 314. Master pattern 420 may comprise a negative mold of features 316 disposed around the circumference of a cylinder in one embodiment. Light (e.g., ultraviolet light, etc.) may be applied from light source 440 to cure material 314, where light source may be rotated to “follow” master pattern 440 (e.g., curing portions of material 314 in which features 316 are formed), held in a fixed position similar to light source 430 (e.g., to cure material 314 after master pattern 420 has finished creating features 316), or otherwise positioned and/or moved to cure material 314.

Once features 316 are created in material 314, optical diffuser film 310 may be rolled in roll 450 for storage, transportation, subsequent use (e.g., in an automated roll-to-roll process, etc.), etc. Alternatively, optical diffuser film 310 may be coupled to substrate 320 (e.g., using adhesive material 330) to form optical diffuser 210. As shown in FIG. 4, adhesive material 330 may be applied to substrate 320 prior to coupling with optical diffuser film 310. However, in other embodiments, adhesive material 330 may be applied to optical diffuser film 310 before coupling with substrate 320.

Although FIG. 4 shows specific steps for producing optical diffuser 210 in a specific order, it should be appreciated that different steps and/or a different ordering of the steps may be used in other embodiments. For example, substrate 320 may be applied to substrate 312 prior to application of material 314 and/or prior to creating features 316 in material 314 in other embodiments. Additionally, it should be appreciated that a larger or smaller number of steps may be performed in other embodiments. Further, it should be appreciated that the functionality of one or more steps may be alternatively performed in other embodiments. For example, features 316 may be alternatively created (e.g., by means other than master pattern 410 or master pattern 420) in other embodiments.

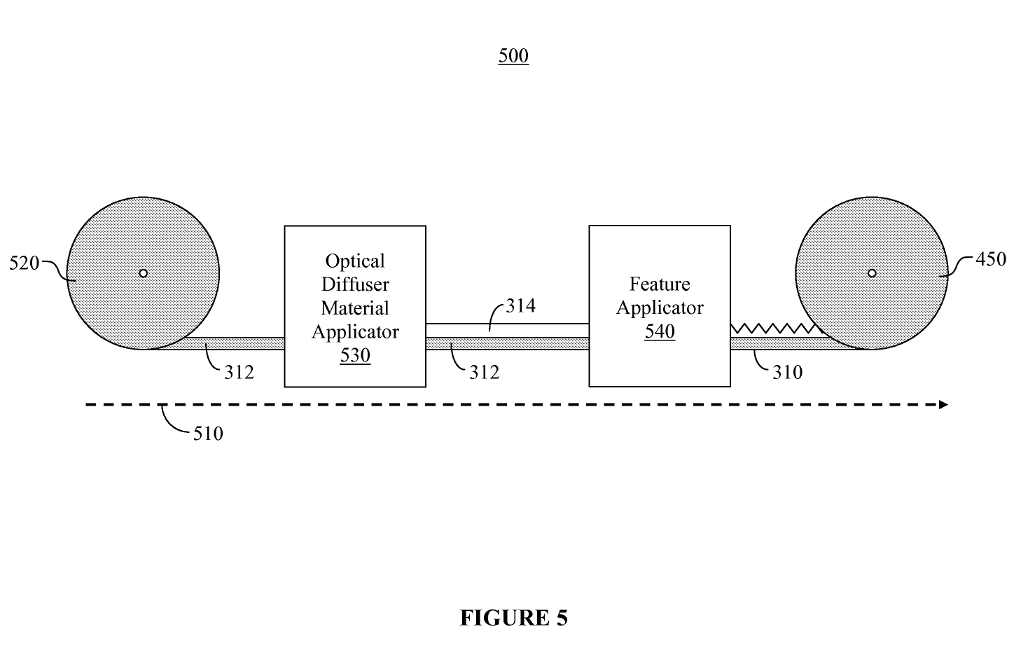

FIG. 5 shows exemplary manufacturing line 500 for manufacturing exemplary optical diffuser film in accordance with one embodiment of the present invention. As shown in FIG. 5, substrate 312 from roll 520 may be fed into optical diffuser material applicator 520 in the direction of arrow 510. Applicator 530 may apply optical diffuser material 314 to substrate 312 and then feed the coated substrate to feature applicator 540. Feature applicator 540 may create features (e.g., 316) in optical diffuser material 314 as discussed above with respect to FIGS. 2 and 3. For example, applicator 540 may emboss the features, chemically etch the features, apply the features through calendaring the surface of material 314, etc. Applicator 540 may then output optical diffuser film 310 which may be rolled or otherwise handled for storage, transportation, subsequent use, etc.

As shown in FIG. 5, creation of optical diffuser film 310 may comprise a roll-to-roll process. Additionally, the process may be automated in one embodiment. As such, optical diffuser film 310 may be manufactured at lower cost and/or in larger volume than conventional optical diffusers which are manufactured with more manual steps, more expensive materials, etc.

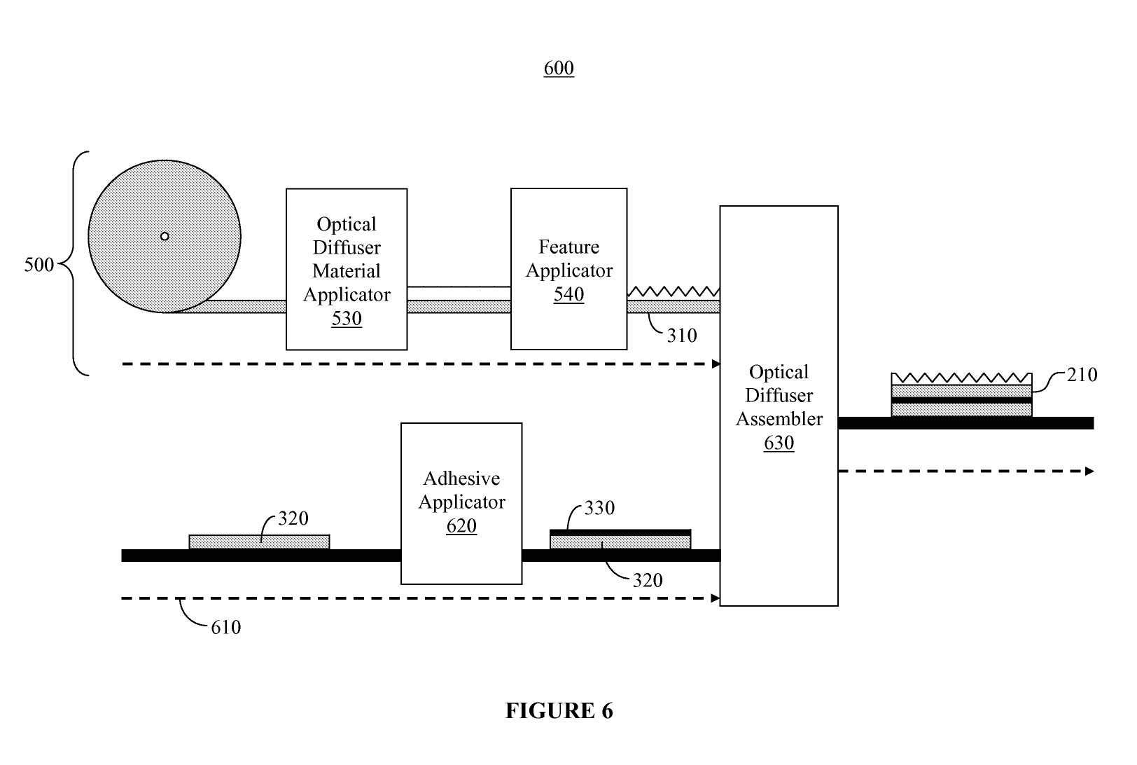

FIG. 6 shows exemplary manufacturing line 600 for manufacturing exemplary optical diffusers in accordance with one embodiment of the present invention. Manufacturing line 600 may implement an automated process in one embodiment. As such, optical diffusers (e.g., 210) may be produced in larger volume and/or at lower cost than conventional optical diffusers.

As shown in FIG. 6, substrate 320 may be fed (e.g., in the direction of arrow 610) into adhesive applicator 620. Applicator 620 may apply adhesive 330 to substrate 320 and then feed the result to optical diffuser assembler 630. Additionally, manufacturing line 500 may provide optical diffuser assembler 630 with optical diffuser film 310. Optical diffuser assembler 630 may then couple substrate 320 to optical diffuser film 310 (e.g., using adhesive 330) to produce and output optical diffuser 210.

Although FIGS. 5 and 6 depict manufacturing lines 500 and 600 with specific components (e.g., 530, 540, 620 and 630) for performing specific functions, it should be appreciated that the functionality may be performed by a larger or smaller number of components in other embodiments. Additionally, it should be appreciated that manufacturing lines 500 and/or 600 may be alternatively configured (e.g., to perform a different number of functions, to perform different functions, to perform the functions in a different order, etc.). For example, feature applicator 540 may be positioned after optical diffuser assembler 630 in one embodiment, and therefore, features (e.g., 316) may be applied to material 314 after optical diffuser assembler 630 couples substrates 320 and 312 (e.g., with adhesive material 330).

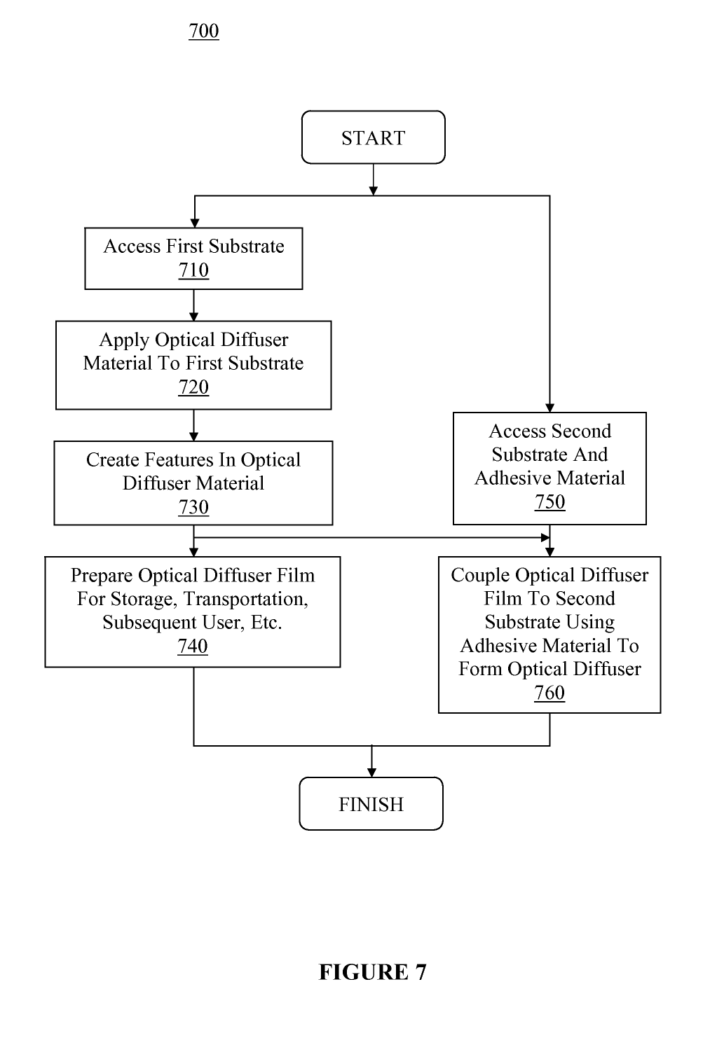

FIG. 7 shows exemplary process 700 for manufacturing an optical diffuser in accordance with one embodiment of the present invention. As shown in FIG. 7, step 710 involves accessing a first substrate (e.g., 312). Step 720 involves applying an optical diffuser material (e.g., 314) to the first substrate (e.g., 312).

Step 730 involves creating features in the optical diffuser material (e.g., 314) to form an optical diffuser film. The features (e.g., 316) may be configured, shaped, arranged, etc. to diffuse light passed through the optical diffuser material. Additionally, the features (e.g., 316) may be created by embossing (e.g., applying a master pattern and curing the optical diffuser material to set or hold the features in place as discussed above with respect to FIGS. 3-6), chemical etching, calendaring, etc. Further, the optical diffuser film (e.g., 310) created in step 730 may be flexible in one embodiment.

As shown in FIG. 7, step 740 involves preparing the optical diffuser film for storage, transportation, subsequent use, etc. Accordingly, the optical diffuser film (e.g., 310) produced in step 730 may be rolled into a roll (e.g., 450), which may provide a compact configuration for easier storage/shipping (e.g., with less damage, etc.) and also enable easy dispensing of the optical diffuser film (e.g., 310) for subsequent use.

Alternatively, after accessing a second substrate (e.g., 320) and an adhesive material (e.g., 330) in step 750, the optical diffuser film (e.g., 310) produced in step 730 may be coupled to the second substrate (e.g., 320) using the adhesive material (e.g., 330) to form an optical diffuser (e.g., 210) in step 760. As such, in one embodiment where the second substrate (e.g., 320) comprises a rigid substrate (e.g., that retains shape under thermal and/or mechanical loading), the second substrate (e.g., 320) may reduce bending, flexing, or other distortion of the optical diffuser film (e.g., 310). Thus, the second substrate (e.g., 320) may improve the optical properties of the optical diffuser film (e.g., 310).

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method of manufacturing an optical diffuser, said method comprising:
adhering an optical diffuser film to a rigid substrate, wherein said rigid substrate is operable to provide structural support for said optical diffuser film, and wherein said optical diffuser film comprises:
a flexible polymer substrate; and
an optical diffuser material comprising a first surface disposed on said flexible polymer substrate, wherein said optical diffuser material further comprises a second surface comprising a plurality of features operable to diffuse light passed through said optical diffuser material, and wherein said first surface of said optical diffuser material is disposed on a third surface of said flexible polymer substrate.

2. The method of claim 1 further comprising:
disposing said optical diffuser material on said flexible polymer substrate; and
embossing said plurality of features into said optical diffuser material.

3. The method of claim 2, wherein said disposing and said embossing are part of a roll-to-roll process.

4. The method of claim 2, wherein said embossing further comprises:
applying a master pattern to said optical diffuser material, said master pattern comprising a second plurality of features operable to create said plurality of features in said optical diffuser material; and
curing said optical diffuser material to form said plurality of features in said optical diffuser material.

5. The method of claim 4, wherein said curing further comprises:
applying ultraviolet light to said optical diffuser material.

6. The method of claim 4, wherein said applying said master pattern further comprises:
pressing said master pattern into said optical diffuser material, wherein said master pattern is substantially-flat in shape.

7. The method of claim 4, wherein said applying said master pattern further comprises:
rolling said master pattern over said optical diffuser material, wherein master pattern is cylindrical in shape.

8. The method of claim 1, wherein said adhering said optical diffuser film to said rigid substrate further comprises adhering said optical diffuser film to said rigid substrate using a pressure-sensitive adhesive.

9. The method of claim 1, wherein said rigid substrate comprises glass.

10. The method of claim 1, wherein said rigid substrate is further operable to reduce thermal deformation of said optical diffuser film.

11. The method of claim 1, wherein a height of said flexible polymer substrate is substantially less than other dimensions of said third surface of said flexible polymer substrate.

12. The method of claim 1, wherein said flexible polymer substrate comprises a polycarbonate film.

13. The method of claim 12, wherein said polycarbonate film is selected from a group consisting of solvent-cast polycarbonate film and chill-rolled polycarbonate film.

14. The method of claim 1, wherein said optical diffuser material comprises an epoxy material.

15. The method of claim 1, wherein said optical diffuser film and said rigid substrate form an optical diffuser for reducing Moiré interference associated with a display device comprising a plurality of overlapping display screens.

16. A method of manufacturing an optical diffuser film, said method comprising:
disposing a first surface of an optical diffuser material on a flexible polymer substrate; and
creating a plurality of features on a second surface of said optical diffuser material, wherein said plurality of features are operable to diffuse light passed through said optical diffuser material, and wherein said first surface of said optical diffuser material is disposed on a third surface of said flexible polymer substrate.

17. The method of claim 16, wherein said creating further comprises embossing said plurality of features into said optical diffuser material.

18. The method of claim 17, wherein said embossing further comprises:
applying a master pattern to said optical diffuser material, said master pattern comprising a second plurality of features operable to create said plurality of features in said optical diffuser material; and
curing said optical diffuser material to form said plurality of features in said optical diffuser material.

19. The method of claim 18, wherein said curing further comprises:
applying ultraviolet light to said optical diffuser material.

20. The method of claim 18, wherein said applying said master pattern further comprises:
pressing said master pattern into said optical diffuser material, wherein said master pattern is substantially-flat in shape.

21. The method of claim 18, wherein said applying said master pattern further comprises:
rolling said master pattern over said optical diffuser material, wherein master pattern is cylindrical in shape.

22. The method of claim 16, wherein said applying and said creating are part of a roll-to-roll process.

23. The method of claim 16, wherein a height of said flexible polymer substrate is substantially less than other dimensions of said third surface of said flexible polymer substrate.

24. The method of claim 16, wherein said flexible polymer substrate comprises a polycarbonate film.

25. The method of claim 24, wherein said polycarbonate film is selected from a group consisting of solvent-cast polycarbonate film and chill-rolled polycarbonate film.

26. The method of claim 16, wherein said optical diffuser material comprises an epoxy material.

27. The method of claim 16, wherein said optical diffuser material is operable to reduce Moiré interference associated with a display device comprising a plurality of overlapping display screens.

28. A method of manufacturing a display device, said method comprising:
positioning a plurality of display screens in an overlapping arrangement; and
positioning an optical diffuser in a position operable to enable said optical diffuser to diffuse light passing through at least one display screen of said plurality of display screens, and wherein said optical diffuser comprises:
a flexible polymer substrate; and
an optical diffuser material comprising a first surface disposed on said flexible polymer substrate, wherein said optical diffuser material further comprises a second surface comprising a plurality of features operable to diffuse said light, and wherein said first surface of said optical diffuser material is disposed on a third surface of said flexible polymer substrate.

29. The method of claim 28, wherein said optical diffuser further comprises a rigid substrate, and wherein said optical diffuser film is disposed on said rigid substrate.

30. The method of claim 29, wherein said rigid substrate comprises glass.

31. The method of claim 29, wherein said rigid substrate is further operable to reduce thermal deformation of said optical diffuser.

32. The method of claim 29, wherein said optical diffuser further comprises:
a pressure-sensitive adhesive operable to adhere said flexible polymer substrate to said rigid substrate.

33. The method of claim 28, wherein said optical diffuser is operable to reduce Moiré interference associated with said plurality of display screens.

34. The method of claim 28, wherein a height of said flexible polymer substrate is substantially less than other dimensions of said third surface of said flexible polymer substrate.

35. The method of claim 28, wherein said flexible polymer substrate comprises a polycarbonate film.

36. The method of claim 35, wherein said polycarbonate film is selected from a group consisting of solvent-cast polycarbonate film and chill-rolled polycarbonate film.

37. The method of claim 28, wherein said optical diffuser material comprises a polymer curable by ultraviolet light.

38. The method of claim 37, wherein said polymer comprises an epoxy material.
